(19) United States
(12) Patent Application Publication
(10) Pub. No.: US 2013/0280359 A1
(43) Pub. Date: Oct. 24, 2013

(54) METHOD FOR THE INTRODUCTION OF A SEAL INTO PLUG CONNECTOR PART

(71) Applicant: IFW Manfred OTTE GMBH, Micheldorf (AT)

(72) Inventors: Andreas DEMMEL, Gmunden (AT); Josef EBNER, Micheldorf (AT)

(21) Appl. No.: 13/921,506

(22) Filed: Jun. 19, 2013

Related U.S. Application Data
(62) Division of application No. 13/124,211, filed on Jun. 20, 2011.

(30) Foreign Application Priority Data
Nov. 10, 2008 (EP) 08019596.9

(51) Int. Cl. B29C 45/14

(52) U.S. Cl. CPC B29C 45/14008
USPC 425/126.1

(57) ABSTRACT

The invention relates to a method for inserting insert parts in an injection moulding die, characterized by the following process steps: Providing the insert parts, receiving the insert parts during the opening process of the injection mould die by means of a suitable device, such as a lever (3), inserting the insert parts in the injection moulding die by moving the device, wherein the movement of the device is carried out by a lever system (4) that is controlled by the movement of the injection moulding die, wherein the device represents a part of the moulding surface (5) when closing the injection moulding die. The invention further relates to executing the injection process and to a device for carrying out the method.

The invention relates to a method and a device for inserting insert parts into an injection mold.

Insert parts are understood here as meaning labels, films, transponder films, thin-walled metal sheets, but also insert parts made of metal, plastic, rubber and the like.

According to the prior art, injection moldings, such as fittings and the like, are provided with product-relevant data, engraved stamps mainly being used for applying this information.

It has already been proposed to insert labels provided with the desired data into an injection mold.

The label may, for example, be inserted into the injection mold manually or by an automatic placement machine.

The object of the invention is to provide a method and a device for inserting insert parts, such as labels, films, transponder films, thin-walled metal sheets, but also insert parts made of metal, plastic, rubber and the like, the device being simple to integrate into the injection mold and the insertion of the insert parts being able to take place without an additional control device.

The subject of the invention is therefore a method for inserting insert parts into an injection mold, characterized by the following method steps:
a) providing the insert parts,
b) receiving the insert parts during the operation of opening the injection mold by means of a suitable device, for example a lever,
c) inserting the insert parts into the injection mold by moving the device, the movement of the device taking place by a lever mechanism which is controlled by the movement of the injection mold, the device representing part of the molding surface during the closing of the injection mold, and
d) carrying out the injecting operation.

A further subject of the invention is a device for inserting insert parts into an injection mold, characterized in that the device comprises the following components:
a container, magazine, roller or dispenser for transferring the insert parts,
a pivotable receiving part, which receives the insert parts and forms part of the molding surface,
a lever mechanism with guiding rollers for pivoting the container, magazine, the roller or the dispenser, and
a vacuum insert, magnet, static charge or mechanical mount for fixing the insert parts on the pivotable receiving part.

Used as insert parts are, for example, labels, threaded parts or pre-formed parts, which are subsequently to be encapsulated with a further injection molding component.

The labels may in this case already be pre-printed and pre-stamped or be printed and stamped in-line, for example by means of a digital printer. Furthermore, the labels may be laser-inscribed, it also being possible, for example, for the label to be coated in advance with nonstoichiometric aluminum oxide. This black coating is then partially evaporated by laser inscription, the inscription then appearing silvery.

A label may be printed with product- and/or use-specific information or functions either off-line or in-line.

Product-relevant information is, for example, information concerning the manufacturer, the material, the production batch, the date of manufacture and the like.

Use-relevant information is, for example, information concerning mechanical or thermal resistances, surfaces (inside/outside), conductivity, feel, optimum processing or installation temperature of the injection molding and the like.

Furthermore, indicators, for example for a temperature indication, moisture indication, indication of gas escape or ingress (impermeability) and the like, may be applied as use-specific information.

If appropriate, customer-specific information, such as for example order data, barcodes for the machine-readable recognition of the injection molding and the like, may also be applied. Furthermore, areas that can be printed on by the customer itself on the finished product, for example by means of an inkjet printer, a thermal transfer printer or a laser printer, may be provided on the label.

In special cases, security elements and/or processing-relevant elements may also be applied, for example RFID transponders, chips, optically active structures, electrically conductive materials or magnetic features, thermochromic features and the like. These elements may serve both for verifying the origin or for identifying the injection molding and for detecting processing-relevant data, such as temperature and the like, or else, in the case of a transponder, for locating the products.

These layers may be applied both partially and completely and be combined with one another.

The receiving part for the insert parts is formed as part of the injection mold. This receiving part preferably takes the form of a lever, which swings out when the mold is opened. After receiving the insert part from the container, the mold is closed. The receiving part is thereby pivoted by the closing movement of the mold into its intended place and again forms part of the molding surface.

To fix the insert parts on the pivotable receiving part, a vacuum insert, magnet, static charge or a mechanical mount is provided. As a result, the insert part is fixed on the receiving part even during the pivoting operation.

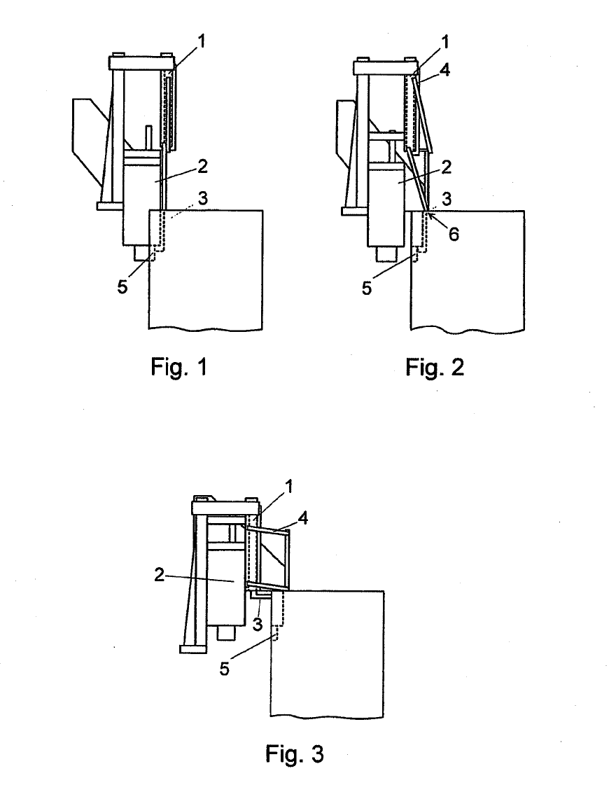

In FIGS. 1 to 3, the device described and the sequence for introducing the insert parts are represented.

In the figures, 1 denotes the magazine which contains the insert parts, 2 the core puller, 3 the lever, 4 the lever mechanism, 5 the molding surface and 6 the pivot point of the lever.

In FIG. 1, the starting position is represented.

The mold is closed.

The magazine (1) which contains the insert parts is located above the core puller.

In FIG. 2, the mold is open a little. The magazine is taken along by the ejector side by means of guiding rollers. The pivotable receiving part (lever), which later during the sequence accepts the insert part, is not yet moved thereby.

In FIG. 3, the further opening operation is represented.

During the further opening of the mold, the movement of the levers (3) by which the magazine is pivoted downward has the effect of activating a further lever mechanism, which articulates the lever (3) in such a way that it pivots out of the mold by 90° and then takes over the insert part from the magazine.

The lever (3) which takes over the insert part represents part of the molding surface (5) when in the retracted state. It has at the location at which it takes over the insert part an insert at which a vacuum is applied (not represented), so that the insert part is fixed during the pivoting-in operation and also during the injecting operation.

1-2. (canceled)

3. A device for inserting insert parts into an injection mold, characterized in that the device comprises the following components:
a container, magazine, roller or dispenser for transferring the insert parts,
a pivotable receiving part, which receives the insert parts and forms part of the molding surface,
a lever mechanism with guiding rollers for pivoting the container, magazine, the roller or the dispenser, and
a vacuum insert, magnet, static charge or mechanical mount for fixing the insert parts on the pivotable receiving part.
